(19) United States
(12) Patent Application Publication
(10) Pub. No.: US 2024/0263746 A1
(43) Pub. Date: Aug. 8, 2024

(54) SYSTEM COMPRISING A CRYOGENIC CONTAINER FOR THE TEMPORARY REDUCTION OF PRESSURE LOSSES

(71) Applicants: Cryoshelter LH2 GmbH, Dobl-Zwaring (AT); Cryoshelter BioLNG GmbH, Dobl-Zwaring (AT)

(72) Inventor: Matthias REBERNIK, Dobl-Zwaring (AT)

(21) Appl. No.: 18/691,333

(22) PCT Filed: Sep. 15, 2022
(86) PCT No.: PCT/EP2022/075623

§ 371 Date: Mar. 12, 2024

(30) Foreign Application Priority Data
Sep. 15, 2021 (AT) GM 50192/2021

(51) Int. Cl. F17C 7/02

(52) U.S. Cl. CPC F17C 7/02; F17C 2205/0323; F17C 2205/0352; F17C 2221/012; F17C 2221/033; F17C 2223/0161; F17C 2227/0306; F17C 2227/0323; F17C 2227/0379; F17C 2227/039; F17C 2250/03; F17C 2250/043; F17C 2250/0439; F17C 2250/0491; F17C 2250/0636; F17C 2265/066; F17C 2270/0168; F17C 2270/0184

(57) ABSTRACT

The invention relates to a system including a cryogenic container, in particular an LNG container or a hydrogen container, an external heat exchanger and an internal heat exchanger with a pressure management system. The system also includes at least one of the following selectively connectable bypass lines for the temporary reduction of pressure losses: a first bypass line for the first heat exchanger tube of the external heat exchanger; a second bypass line for the second heat exchanger tube; a third bypass line for the internal heat exchanger.

### BACKGROUND AND RELEVANT ART

The invention relates to a system comprising a cryogenic container, in particular an LNG container or a hydrogen container, an external heat exchanger and an internal heat exchanger, wherein the external heat exchanger has a medium inlet and a medium outlet for heat exchange medium and the internal heat exchanger is arranged within the cryogenic container for utilizing the cryogenic fluid located in the cryogenic container as a heat exchange medium, wherein the external heat exchanger comprises a first heat exchanger tube with a first inlet and a first outlet and a second heat exchanger tube with a second inlet and a second outlet: wherein the internal heat exchanger comprises a third inlet and a third outlet: wherein a removal line of the cryogenic container is connected to the first inlet of the external heat exchanger, with an output line being connected to a first outlet of the external heat exchanger, with a branch line being connected to the output line at a first node and being connected to the third inlet of the internal heat exchanger, with a first return line being connected to the third outlet of the internal heat exchanger and being connected to the second inlet of the external heat exchanger; and wherein a second return line is connected to the second outlet of the external heat exchanger and is connected to the output line at a second node, the second node being located downstream of the first node.

According to the prior art, liquefied gases can be stored in containers (“cryogenic containers”) so as to be stored as a fuel for an engine, for example. Liquefied gases are gases that are in the liquid state at boiling temperature, with the boiling temperature of this fluid being pressure-dependent. If such a cryogenic liquid is filled into a cryogenic container, a pressure corresponding to the boiling temperature is established, apart from thermal interactions with the cryogenic container itself.

In the application field of automotive engineering, the cryogenic fluid can serve as a fuel for a vehicle, for which purpose the cryogenic container is carried along on the vehicle. The cryogenic fluid should be supplied to the engine of the vehicle—generally to a consumer—at a predetermined minimum temperature. Since the cryogenic fluid is usually stored at temperatures of below −40° C. and, for example, in a liquefied form (e.g., supercritical, cryocompressed or sLH2), but should normally be supplied to the consumer in a gaseous form, wherein common components such as injection valves are usually suitable only for (continuous) operating temperatures greater than approximately −40° ° C., an external heat exchanger is provided in order to heat the cryogenic fluid at least to this predetermined minimum temperature for being supplied to the consumer. Maintaining this minimum temperature is therefore a must, at least for the continuous operation of the cryogenic tank, with exceptions being possible only for a limited time. In other applications, the cryogenic fluid can be supplied to the consumer also at cryogenic temperatures of, e.g., −240° C.

Another requirement for cryogenic containers, particularly in the automotive sector, is that the cryogenic fluid should be supplied to the consumer at a predetermined minimum pressure. For this purpose, the cryogenic fluid is stored in the cryogenic container at a pressure which is above said minimum pressure, for example, by at least a predetermined pressure difference, the predetermined pressure difference corresponding at least to a pressure loss of the removal system.

However, since a large mass of cryogenic fluid is removed from the cryogenic container during prolonged operation, the pressure in the cryogenic container decreases steadily. In order to maintain the pressure in the cryogenic container during operation, a so-called pressure management system is provided, as it is known, for example, from WO 2021/026580 A1. The purpose of the pressure management system is that cryogenic fluid heated by the external heat exchanger is branched off from the removal line and is recirculated through a further heat exchanger protruding into the cryogenic container, whereby the pressure in the cryogenic container can be increased.

On the one hand, it is thus attempted to keep the pressure in the cryogenic container high enough so that there is always a sufficiently high pressure at the end of the removal system. On the other hand, however, the pressure in the cryogenic container should not be too high, since a high pressure is associated with a shortened hold time, the hold time being the time span from the end of the removal to the point in time at which the pressure in the cryogenic container reaches a predefined threshold.

It is generally desirable to extend the hold time of the cryogenic container. Appropriate further developments in the field of cryogenic containers involve, for the extension of the hold time, that the cryogenic container is better insulated or the pressure loss of the removal system is reduced, for example, in that the pipelines used are designed shorter or with a larger diameter.

### BRIEF SUMMARY

It is the object of the invention to improve the removal system of a cryogenic container with regard to these problems.

This object is achieved by a system comprising a cryogenic container, in particular an LNG container or a hydrogen container, an external heat exchanger and an internal heat exchanger, wherein the external heat exchanger has a medium inlet and a medium outlet for (externally supplied) heat exchange medium and the internal heat exchanger is arranged within the cryogenic container for utilizing the cryogenic fluid located in the cryogenic container as a heat exchange medium, wherein the external heat exchanger comprises a first heat exchanger tube with a first inlet and a first outlet and a second heat exchanger tube with a second inlet and a second outlet, or wherein the external heat exchanger comprises only a first heat exchanger tube with a first inlet and a first outlet and the system furthermore comprises a further external heat exchanger with a second heat exchanger tube with a second inlet and a second outlet: wherein the internal heat exchanger comprises a third inlet and a third outlet: wherein a removal line of the cryogenic container is connected to the first inlet of the external heat exchanger, with an output line being connected to a first outlet of the external heat exchanger, with a branch line being connected to the output line at a first node and being connected to the third inlet of the internal heat exchanger, with a first return line being connected to the third outlet of the internal heat exchanger and being connected to the second inlet of the external heat exchanger; and wherein a second return line is connected to the second outlet of the external heat exchanger and is connected to the output line at a second node, the second node being located downstream of the first node: the system comprising at least one of the following selectively connectable bypass lines for temporarily reducing pressure losses and/or for influencing the gas temperature (cryogenic fluid temperature):
a first bypass line for the first heat exchanger tube of the external heat exchanger, the first bypass line preferably being connected to the removal line directly (i.e., without a further connecting line starting between the bypass line and the first inlet, although valves, sensors can be provided therebetween) upstream of the first inlet and preferably being connected to the output line directly downstream of the first outlet:
a second bypass line for the second heat exchanger tube of the external heat exchanger, the second bypass line preferably being connected to the first return line directly upstream of the second inlet and preferably being connected to the second return line directly downstream of the second outlet:
a third bypass line for the internal heat exchanger, the third bypass line preferably being connected to the branch line directly upstream of the third inlet and preferably being connected to the first return line directly downstream of the third outlet.

The purpose of the bypass lines is that the heat exchangers can be connected in parallel for a short time if necessary in order to temporarily reduce the pressure loss. The invention is based on the realization that the heat exchangers that are usually required entail a relatively major pressure loss, but that it is not necessary in all cases to guide the cryogenic fluid through the heat exchangers.

The temporary reduction in pressure losses can be utilized for reducing the pressure in the cryogenic container, since a lower pressure in the cryogenic container is now required for supplying the cryogenic fluid at a predetermined pressure to a consumer such as the engine of a vehicle. The pressure pKB in the cryogenic container now just has to be above the required minimum pressure pmin by the reduced pressure loss Δp of the removal system.

The lower pressure achieved in the cryogenic container entails an increased hold time after the consumer or, respectively, the vehicle has been switched off, since the period of time until the pressure in the cryogenic container reaches a predetermined threshold will be longer.

A further advantageous effect of the invention is that the temperature of the cryogenic fluid at the end of the removal system can be kept as low as possible, but still above the minimum temperature of the consumer. Due to the low temperature of the cryogenic fluid, the consumer can operate more efficiently or, respectively, the consumer can be kept at an operating temperature more efficiently and with less energy input.

The invention thus creates the possibility of dynamically adjusting the pressure losses in the removal system of a cryogenic container, depending on the conditions prevailing in the system. For example, at a start of the system, the cryogenic fluid present downstream of the second node could just be sufficiently warm for the pressure loss not to be reducible at this point in time, due to a relatively cold heat exchange medium (e.g., waste heat from the consumer). However, at a later point in time, warmer heat exchange medium might be available (because, for example, the consumer has become warmer and therefore its waste heat has also increased) so that the entire cryogenic fluid removed via the cryogenic container no longer has to be guided via the external heat exchanger, for example, by increasing the mass flow via the first bypass line. Due to the pressure loss reduced in this way, the pressure in the cryogenic container can be reduced, whereby the hold time of the cryogenic container is increased.

The effects according to the invention already occur when one of the bypass lines is provided, since, at least, an optimization of the system is enabled for certain operating situations. However, an optimal solution that brings about an improvement in the pressure or, respectively, temperature control in the system for all or, respectively, more operating situations is possible if all three of the mentioned bypass lines are provided.

In the simplest case, said first, second and/or third bypass line can be connected thereto manually, for example if an appropriate valve is switched manually in the respective bypass line. In one embodiment, control lines could be routed into the driver's cab, and a driver of the vehicle could manually operate a control button, e.g., if they know from experience or from a measured value that the heat exchange medium is now warm enough so as to no longer allow the entire cryogenic fluid to flow via the external heat exchanger.

However, it is preferred if the system comprises a control device and at least one sensor for determining pressure readings and/or temperature readings, the sensor being arranged in the cryogenic container, in the removal line, in the first return line, in the second return line or in the output line, the control unit being designed for controlling a mass flow of cryogenic fluid through the first, second and/or third bypass line depending on the pressure readings and/or temperature readings received from the sensor, in particular with the aim of reducing the pressure loss of the removal system or, respectively, the pressure in the cryogenic container. Through the control unit, a fully automatic system is created by means of which the pressure loss of the removal system can be minimized continuously during operation, without the need for user intervention.

It is particularly preferred if the control unit solves an optimization problem, for example continuously or at discrete time intervals. For this purpose, the control unit is designed for receiving or determining a temperature downstream of the second node, a pressure downstream of the second node and a pressure in the cryogenic container and for controlling a mass flow via the branch line, the first, second and/or third bypass line, under the conditions that the temperature downstream of the second node is at or above a predetermined minimum temperature (but simultaneously particularly preferably as low as possible. i.e., as close to the minimum temperature as possible, or not exceeding a maximum temperature), the pressure downstream of the second node is at or above a predetermined minimum pressure and the pressure in the cryogenic container is minimized. The control unit can receive or determine the pressure or, respectively, the temperature downstream of the cryogenic container, e.g., directly from a sensor arranged there, by using the temperatures or, respectively, pressures upstream of the node in the output line or, respectively, in the second return line and, optionally, a mass flow ratio.

The optimization problem as mentioned can, for example, be solved analytically, for which additional sensor readings can also be used. However, the control can also be simplified or, respectively, supported if simple rules are stored in the control unit, for example, one or several of the following rules:
the mass flow through the first bypass line is increased when the temperature downstream of the second node is above a predetermined threshold:
the mass flow through the second bypass line is increased when the temperature downstream of the second node is above a predetermined threshold:
the mass flow through the third bypass line is increased when the temperature downstream of the second node is below a predetermined threshold:
the mass flow through the branch line is increased when the pressure downstream of the second node is below a predetermined threshold.

The bypass lines enable, in particular, a temporary reduction in the pressure loss in systems in which the temperature of the heat exchange medium changes, e.g., if the temperature of the heat exchange medium is due to waste heat from the consumer, i.e., the heat exchange medium is provided at a first temperature at the onset of an operation and, after a predetermined period of time upon the onset of the operation, the heat exchange medium is provided at a second temperature which is higher than the first temperature. In other cases, the temperature can also simply be due to an ambient temperature, i.e., in summer, the heat exchange medium will, for example, have a higher average temperature than in winter. In such cases, the following two embodiments are preferred.

In the first embodiment, the external heat exchanger is dimensioned for a cold start, i.e., the external heat exchanger allows cryogenic fluid to be heated to the predetermined minimum temperature, which is required for the consumer, even with a relatively cold heat exchange medium. However, this involves also that the heat exchanger heats the cryogenic fluid to an unnecessarily high level if the heat exchange medium is warmer. In this embodiment, the heat exchanger is thus designed for bringing the cryogenic fluid at least to the predetermined minimum temperature of a consumer at the onset of the operation when the cryogenic fluid is being passed through the heat exchanger once. The temporary reduction in the pressure loss can now be achieved if the control unit is designed so as not to guide any mass flow of cryogenic fluid via the first bypass line and/or the second bypass line at the onset of the operation and for guiding a mass flow of cryogenic fluid via the first bypass line and/or the second bypass line after the predetermined period of time, optionally under the condition that the temperature downstream of the second node is at a predetermined minimum temperature.

In the second embodiment, the heat exchanger can, for the first time, also be underdimensioned for the cold start, i.e., the heat exchanger is designed for bringing the cryogenic fluid only to a temperature below the predetermined minimum temperature of a consumer at the onset of the operation when the cryogenic fluid is being passed through the heat exchanger once. The heat exchanger can thus receive a particularly short design and therefore, as such, already has a minor pressure loss. It is rendered possible for the first time that the removal system can also be used with such an underdimensioned heat exchanger, e.g., if the control unit is designed for guiding a mass flow of cryogenic fluid via the third bypass line at the onset of the operation, optionally under the condition that the temperature downstream of the second node is at a predetermined minimum temperature, and so as not to guide any mass flow of cryogenic fluid via the third bypass line after a predetermined period of time. At the onset of the operation, the cryogenic fluid is thus guided through the heat exchanger several times. However, since the heat exchanger can be designed shorter and is guided in continuous operation only once via the heat exchanger, after the cryogenic fluid has been heated, an overall reduction in pressure loss is achieved.

Furthermore, the arrangement according to the invention can be used to permit the operation of the consumer even if the pressure in the cryogenic container is, per se, too low, e.g., in the event of misfuelling of the cryogenic container. For this purpose, the control unit can be designed for increasing the mass flow of cryogenic fluid via the first bypass line when the pressure in the cryogenic container or downstream of the second node is below a predetermined threshold, the control unit preferably being designed for relaxing or suspending a condition regarding a required minimum temperature of the consumer. Relaxing or suspending the condition can occur over a predetermined period of time, e.g., for 10 minutes, or until the minimum temperature of the consumer is reached. In this case, the consumer can thus be operated at least at low load, whereby, for example, the heat exchange medium can be heated, which, in turn, can increase the pressure in the cryogenic container. In this mode, it is preferred to guide at least a certain mass flow of cryogenic fluid via the branch line and preferably to guide the entire mass flow of cryogenic fluid via the second bypass line in order to heat the cryogenic container with the lowest possible pressure loss.

So that it is possible to control what proportion of cryogenic fluid is guided via the respective bypass line, valves can be provided in or, respectively, at the bypass lines as follows: the first bypass line can have a valve at the connection point to the removal line, a valve at the connection point to the output line or a valve between said connection points; the second bypass line can have a valve at the connection point to the first return line, a valve at the connection point to the second return line or a valve between said connection points; and/or the third bypass line can have a valve at the connection point to the branch line, a valve at the connection point to the first return line or a valve between said connection points. Furthermore, a valve can optionally be provided in the line section to be connected in parallel. The control unit is preferably connected to these valves in order to control the mass flow guided via the bypass line.

As already indicated above, it is particularly preferred if the system is used in combination with a vehicle and the output line is connected to a consumer, in particular an engine or a fuel cell, of the vehicle, the consumer being designed for operation in normal mode, when the consumer receives cryogenic fluid at a predetermined minimum temperature and a predetermined minimum pressure.

### BRIEF DESCRIPTION OF THE DRAWINGS

Advantageous and non-limiting embodiments of the invention are explained in further detail below with reference to the drawings.

FIG. 1 shows a removal system comprising a pressure management system according to the prior art.

FIG. 2 shows a removal system according to the invention comprising a pressure management system.

FIGS. 3a to 3d show variants of possible valve arrangements for the bypass lines according to the invention.

FIG. 4 shows a further development of the removal system of FIG. 2.

### DETAILED DESCRIPTION

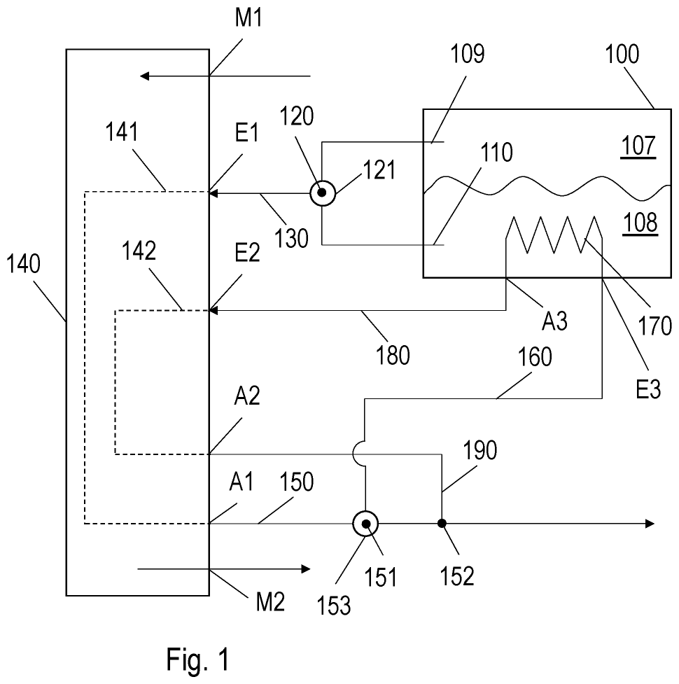

FIG. 1 shows a generally known removal system of a cryogenic container 100, which stores cryogenic fluid in the gaseous state 107 or in the liquid state 108. For example, the cryogenic fluid can be hydrogen so that the cryogenic container 100 is a hydrogen container, or the cryogenic fluid can be LNG (Liquefied Natural Gas) so that the cryogenic container is an LNG container. Depending on the cryogenic fluid, the cryogenic container is thus designed for storing cryogenic fluid at temperatures of, for example, below 150 Kelvin, in case of hydrogen even of below 50 Kelvin or below 30 Kelvin or essentially of 20 Kelvin. Depending on the application, the cryogenic container 100 could be designed, for example, for storing sLH2 (subcooled liquid hydrogen) or CcH2 (cryo-compressed hydrogen) and thus also for corresponding high pressures, for example for maximum pressures of between 5 bar and 350 bar. Therefore, the two phases can also exist only temporarily.

The cryogenic container 100 described herein is usually used as a fuel tank of a vehicle (not illustrated any further) and can be mounted for this purpose, for example, on the vehicle frame of the vehicle. For supplying the cryogenic fluid as a fuel to a consumer, e.g., a drive such as an engine or a fuel cell, of the vehicle, two removal lines 109, 110 are routed into the cryogenic container 100. The first removal line 109 is routed into the area which, in the operating position of the cryogenic container 100, is at the top in order to remove gaseous cryogenic fluid, and the second removal line 110 is routed into the area which, in the operating position of the cryogenic container 100, is at the bottom in order to remove liquid cryogenic fluid. The removal lines 109, 110 pass either through the cryogenic container jacket or through one of the end caps of the cryogenic container 100 and are thus routed out of the cryogenic container 100. The removal lines 109, 110 converge at a node 120 and are continued there as a common removal line 130. By means of one or several economizer valves 121 in the removal lines 109, 110, 130, it is possible to control as to whether cryogenic fluid is removed from the cryogenic container 100 in the liquid phase or in the gas phase, which is known as the so-called economizer function. In the simplest case, just a single removal line 130 could also be routed into the cryogenic container 100.

Since the cryogenic fluid is to be supplied to the consumer at a predetermined minimum temperature, the cryogenic container 100 comprises an external heat exchanger 140 with a first heat exchanger tube 141 having a first inlet E1 and a first outlet A1. The removal line 130 is connected to the first inlet E1 of the first heat exchanger tube 141. In order to supply the cryogenic fluid heated by the external heat exchanger 140 to the consumer, an output line 150 is connected to the first outlet A1 of the first heat exchanger tube 141.

In order to heat the cryogenic fluid located in the first heat exchanger tube 141, a heat exchange medium, which enters the external heat exchanger 140 via a medium inlet M1 and exits therefrom via a medium outlet M2, is flushed around it. The heat exchange medium is usually heated by waste heat from the vehicle or, respectively, the consumer so that, when the consumer, e.g., the engine or, respectively, the fuel cell, begins to operate, the heat exchange medium is cooler than during operation, i.e., after a predetermined period of time after the start of operation.

It is generally known that the pressure in the cryogenic container 100 is reduced when cryogenic fluid is removed from the cryogenic container 100 during operation. For again increasing the pressure in the cryogenic container 100, it is furthermore known to provide a so-called pressure management system in the removal system. For this purpose, a branch line 160 is connected to the output line 150 at a first node 151. The branch line 160 is connected to a third inlet E3 of an internal heat exchanger 170, which protrudes into the cryogenic container 100. The warm cryogenic fluid guided into the internal heat exchanger 170 increases the temperature and thus the pressure in the cryogenic container 100, whereby the desired influence on the pressure in the cryogenic container 100 is achieved.

Subsequently, the cryogenic fluid which has been guided through the internal heat exchanger 170—and now is cold again—is passed once more through the external heat exchanger 140 in order to heat the cryogenic fluid. For this purpose, the external heat exchanger 140 comprises a second heat exchanger tube 142 with a second inlet E2 and a second outlet A2. Alternatively, a further external heat exchanger separate from the external heat exchanger 140 can be used (not illustrated), which comprises the second heat exchanger tube 142. The further heat exchanger can again comprise a medium inlet and a medium outlet for heat exchange medium, for instance, the same heat exchange medium like for heat exchanger 140.

A first return line 180 connects the third outlet A3 of the internal heat exchanger 170 to the second inlet E2 of the second heat exchanger tube 142. A second return line 190 connects the second outlet A2 of the second heat exchanger tube 142 to the output line 150 at a second node 152, the second node 152 being arranged downstream of the first node 151. For controlling as to which proportion of the mass flow in the output line 150 flows via the pressure management system, i.e., via the internal heat exchanger 170, one or several pressure management valves 153 is/are provided, which are arranged, for example, at the first node 151. Optionally, the second heat exchanger tube 142 can also be omitted, and the cryogenic fluid from the first return line 180 can again be recirculated directly at the second node 152.

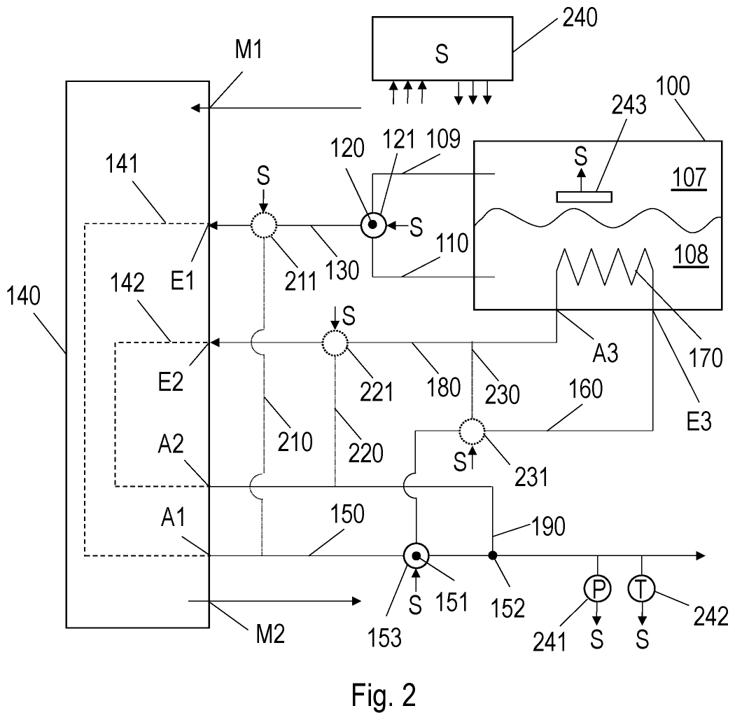

FIG. 2 now shows the system according to the invention, which advances the system of FIG. 1. Since all components are used equally or similarly to FIG. 1, the same reference symbols are used. All variants described for FIG. 1 can also be used in the system of FIG. 2. Since the heat exchanger tubes 141, 142 or, respectively, the heat exchanger 170 is/are usually designed as spiral tubes, coiled tubes, etc., they entail a certain pressure loss, which is generally accepted. However, it has now become apparent that certain pressure losses are indeed sometimes unavoidable, but that minimizing these pressure losses can be of utmost importance for the usefulness of the vehicle, depending on the situation.

For this reason, it is now planned to provide at least one, preferably two or all three, of the following selectively connectable bypass lines 210, 220, 230 for the temporary reduction of pressure losses:
a first bypass line 210 for the first heat exchanger tube 141, the first bypass line 210 preferably being connected to the removal line 130 directly upstream of the first inlet E1, e.g., between the first inlet E1 and the node 120, and preferably being connected to the output line 150 directly downstream of the first outlet A1, e.g., between the first outlet A1 and the first node 151:
a second bypass line 220 for the second heat exchanger tube 142, the second bypass line 220 preferably being connected to the first return line 180 directly upstream of the second inlet E2, e.g., between the second inlet E2 and the third outlet A3 or, respectively, the connection point of the third bypass line 230, and preferably being connected to the second return line 190 directly downstream of the second outlet A2, e.g., between the second outlet A2 and the second node 152;
a third bypass line 230 for the internal heat exchanger 170, the third bypass line 230 preferably being connected to the branch line 160 directly upstream of the third inlet E3, e.g., between the third inlet E3 and the first node 151, and preferably being connected to the first return line 180 directly downstream of the third outlet A3, e.g., between the third outlet A3 and the second inlet E2 or, respectively, the connection point of the second bypass line 220.

Since the bypass lines 210, 220, 230 have a lower pressure loss than the heat exchanger tubes 141, 142 or, respectively, the heat exchanger 170, the pressure loss of the removal system can be reduced if a mass flow via the bypass lines 210, 220, 230 is increased, while the mass flow via the heat exchanger tubes 141, 142 or, respectively, the heat exchanger 170 is simultaneously reduced. For this purpose, valves 211, 221, 231 are provided at or, respectively, in the bypass lines 210, 220, 230.

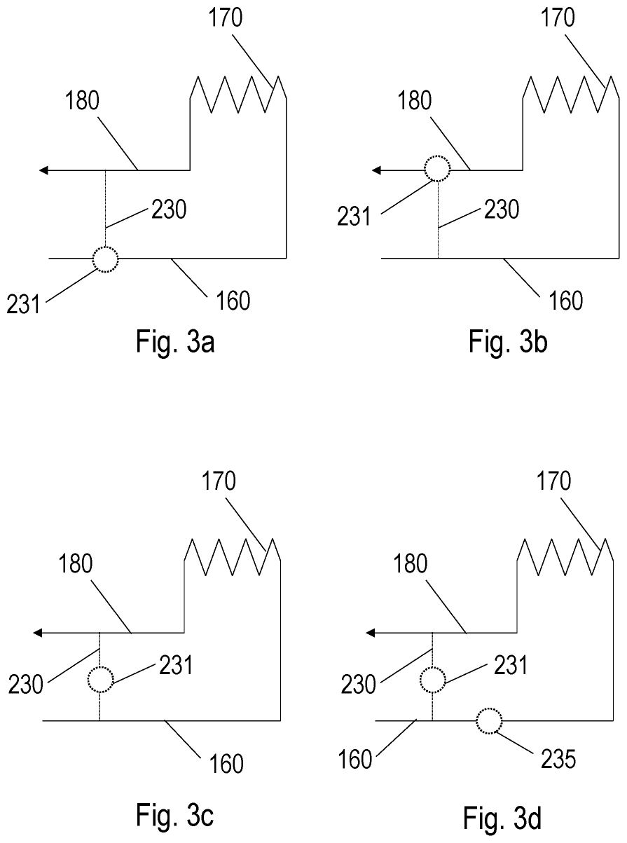

The valves 211, 221, 231 either can be operated manually or can be actuated via a control unit 240, for which purpose the valves 211, 221, 231 can communicate with the control unit via control lines or wirelessly. In FIG. 2, it is illustrated that the valves are provided at an inlet connection point of the bypass lines 210, 220, 230. This is highlighted again in FIG. 3a. However, the valves 211, 221, 231 could alternatively also be provided at the outlet connection point of the bypass lines 210, 220, 230, as is illustrated in FIG. 3b. In these two embodiments, the valves 211, 221, 231 are usually designed as multi-way valves in order to control by means of a valve how much cryogenic fluid flows via the respective bypass line 210, 220, 230 and how much cryogenic fluid flows via the respective heat exchanger tube 141, 142 or, respectively, the heat exchanger 170. The multi-way valves can be designed as proportional valves for selectively throttling the connection. As a result, it is possible, for example, to open the connection to the respective bypass line 210, 220, 230 by X % and, regardless of that, to open the connection to the respective heat exchanger tube 141, 142 or, respectively, to the heat exchanger 170 by 100-X %, wherein 0≤X≤100. Alternatively, the multi-way valve could be designed for opening the connection to the respective bypass line 210, 220, 230 by between 0-100% and, regardless of that, for opening the connection to the respective heat exchanger tube 141, 142 or, respectively, to the heat exchanger 170 by between 0-100%. These different embodiments serve the purpose of minimizing the pressure losses between the cryogenic container and the consumer (e.g., the engine or the fuel cell). The pressure losses are lost as an unusable pressure interval for the hold time (storage period free from blowing off). At the same time, there is a desire to be able to consciously set pressure differences between certain line paths in certain operating states.

FIG. 3c shows that the valves 211, 221, 231 can also be configured between the connection points to the respective lines. In this embodiment, the valves 211, 221, 231 can be proportional valves, i.e., they can be designed as simple 2/2-way valves and can be opened by between 0-100%. Alternatively, the valves 211, 221, 231 could only have discrete switching states, e.g., they could only be closed completely or opened completely and, if necessary, they could assume an intermediate position of being, for example, 50% open. As shown in FIG. 3c, one valve is generally sufficient, since the respective heat exchanger tube 141, 142 or, respectively, the heat exchanger 170 constitutes a resistance and most of the cryogenic fluid will thus flow via the respective bypass line 210, 220, 230, when the valve 211, 221, 231 is completely opened. However, as shown in FIG. 3d, a further valve 235 can also be provided, which is arranged in the line of the heat exchanger tube 141, 142 or heat exchanger 170 to be connected in parallel. FIGS. 3a-3d show this configuration based on the third bypass line 230 for connecting the internal heat exchanger 170 in parallel, wherein such configurations can, of course, also be provided for the first and/or second bypass line(s) 210, 220.

For the control unit 240 to be able to determine when a mass flow of cryogenic fluid should be guided via the bypass lines 210, 220, 230, the following boundary conditions are used. For operating the consumer in a normal operating mode, this cryogenic fluid is to be provided at a predetermined minimum pressure pmin and a predetermined minimum temperature Tmin. The minimum pressure pmin and the minimum temperature Tmin are thus determined as such by the consumer.

For determining at what pressure or, respectively, at what temperature the cryogenic fluid is currently being supplied to the consumer, a pressure sensor 241 and a temperature sensor 242 can be arranged in the output line 150 downstream of the second node 152. In this case, the control unit 240 could directly receive the temperature and the pressure of the cryogenic fluid in the output line 150 downstream of the second node 152. However, this is not absolutely necessary, since pressure sensors or temperature sensors can also be provided at other locations, e.g., in one or several of the bypass lines 210, 220, 230, in the removal line 109, 110, 130, in the output line 150 between the two nodes 151 and 152 or upstream of the first node 151, in the branch line 160 or in the first or second return line 180, 190. As an alternative or in addition to the pressure sensors or, respectively, the temperature sensors, in particular mass flow meters could also be arranged at said locations. Sensors designed for determining the temperature, the pressure and/or the mass flow can also be used.

Moreover, it is particularly preferred if a pressure sensor and/or a temperature sensor 243 is arranged in or, respectively, at the cryogenic container 100 in order to determine the pressure or, respectively, the temperature in the cryogenic container 100.

Depending on the measuring data received or, respectively, determined by the sensor(s) 241, 242, 243, the control unit 240 can now control a mass flow of cryogenic fluid through the first, second and/or third bypass line 210, 220, 230 depending on the pressure readings and/or temperature readings or, respectively, mass flow readings received from the sensor in that the corresponding valves 211, 221, 231 in the bypass lines 210, 220, 230 or, respectively, the valve 121 for providing the economizer function and/or the valve 153 are actuated appropriately. The control of the mass flow is usually performed with the aim that the temperature downstream of the second node 152 is at or above a predetermined minimum temperature Tmin, the pressure downstream of the second node 152 is at or above a predetermined minimum pressure pmin and the pressure pKB in the cryogenic container 100 is minimized.

This optimization problem could basically be solved analytically or else through a machine learning algorithm. To a certain extent, a trial-and-error method could also be used by actuating one or several of the valves and observing or, respectively, evaluating the effect on the state of the cryogenic fluid downstream of the second node 152.

However, concrete rules can also be established and stored in the control unit 240, based on which the control unit actuates the valves 211, 221, 231 and also the valve 153. This will be explained in further detail below.

### Maintaining the Predetermined Minimum Temperature Tmin

Since the cryogenic fluid is usually stored at temperatures below −40° C. and the minimum temperature Tmin of the components downstream of the tank system, e.g., for automotive areas of application for continuous operation, is usually approximately −40° C., the cryogenic fluid is passed through the first heat exchanger tube 141 in order to heat the cryogenic fluid at least to said temperature Tmin for supply to the consumer. Maintaining this minimum temperature is therefore a requirement at least for the continuous operation of the cryogenic container 100, with short-term exceptions being possible.

As already mentioned, the heat exchange medium is usually heated by waste heat from the vehicle so that, when the consumer, e.g. the engine or the fuel cell, is started, the heat exchange medium is cooler than during operation. Usually, the heat exchanger 140 is dimensioned such that, at a “cold start” of the vehicle, sufficient cryogenic fluid can be provided for full load operation (at least a sufficiently high load) with at least the minimum temperature Tmin. The “cold start” temperature of the heat exchange medium is typically specified by the vehicle manufacturer and can be, for example, −30° C. or −20° C.

Since the temperature of the heat exchange medium can rise significantly during operation, e.g., to +80° C. or to +120° C., the temperature of the provided cryogenic fluid will also be significantly above Tmin, as a result of the required “cold start” dimensioning of the heat exchanger 140. Because of the lower density at such a higher temperature, the pressure loss via the heat exchanger 140 will also be higher for the same flow rate than at lower temperatures.

The heat exchanger 140 can now be connected in parallel at least partially through the connecting line 210, whereby proportional control of the two partial flows via the first heat exchanger tube 141 and the bypass line 210 is achieved so that, upon mixing the two partial flows at least up to the point of entry of the cryogenic fluid into the consumer (engine, fuel cell), the predetermined minimum temperature Tmin can be reached or, respectively, exceeded.

Since the first bypass line 210 is routed outside of the heat exchanger 140 and can also be designed shorter and with a larger diameter without the need to increase the temperature, the pressure loss via this bypass line 210 is lower than via the first heat exchanger tube 141, and the pressure loss of the entire mass flow (i.e., the sum of the partial flows via the first heat exchanger tube 141 and via the first bypass line 210) is thus lower than via the first heat exchanger tube 141 alone.

Furthermore, the first bypass line 210 also allows the cryogenic fluid provided by the removal system to be controlled selectively and thus its temperature to be lowered. The necessary cooling capacity of the consumer is thereby reduced appropriately, and the performance is increased and optimized appropriately due to the higher density of the provided fuel (cryogenic fluid), generally improving the efficiency of the drive.

One of the rules stored in the control unit 240 can therefore be that the mass flow through the first bypass line 210 is increased if the temperature downstream of the second node 152 is above a predetermined threshold. This threshold could be, for example, the predetermined minimum temperature Tmin or, for example, Tmin+T1, wherein T1 is, for example, 10% of Tmin or an absolute amount.

In other embodiments, the cryogenic fluid can be supplied to the consumer also at cryogenic temperatures, e.g., at −240° C., which depends on the specific consumer, so that the external heat exchanger 140 is used only for introducing heat into the cryogenic container 100 via the internal heat exchanger 170 rather than for increasing the temperature for the consumer.

### Maintaining the Predetermined Minimum Pressure Pmin

Prolonged operation with high load leads to a pressure drop due to the mass of cryogenic fluid correspondingly removed from the tank. By supplying heat to the inner tank via the internal heat exchanger 170, this pressure drop can be avoided or, respectively, periodically compensated for.

For this purpose, as already explained above, a partial flow of the already heated fluid is branched off via the branch line 160 at node 151 and is guided via the internal heat exchanger 170, where the cryogenic fluid cools down due to the heat dissipation to the colder stored cryogenic fluid, possibly also below the predetermined minimum temperature Tmin.

Another one of the rules stored in the control unit 240 can therefore be that the mass flow through the branch line 160 is increased if the pressure downstream of the second node 152 is below a predetermined threshold. This threshold could be, for example, the predetermined minimum pressure pmin or, for example, pmin+p1, wherein p1 is, for example, 10% of pmin or an absolute amount.

In order to optimize the performance of the internal heat exchanger 170, the return flow is once again guided via the second heat exchanger tube 142, which is again designed with a correspondingly high pressure loss. The performance of the internal heat exchanger 170 is fully achieved if the entire removed mass flow can be guided via the internal heat exchanger 170 and this can again be heated at least to above the predetermined minimum temperature Tmin in the second heat exchanger tube 142. This performance determines the maximum power (=mass flow) which the cryogenic tank system can provide to the consumer.

Depending on the dimensioning of the internal heat exchanger 170 and the second heat exchanger tube 142, which can generally also be shorter than the first heat exchanger tube 141, performance limits of the system arise, always with the proviso that, after the partial streams have mixed, the temperature of the cryogenic fluid downstream of the second node 152 is above the predetermined minimum temperature Tmin at least immediately before entering the consumer.

The second bypass line 220 hereby allows the second heat exchanger tube 142 to be connected in parallel, whereby, in turn, lower pressure losses are enabled than if the entire cryogenic fluid is guided via the second heat exchanger tube 142, thereby enabling the performance of the internal heat exchanger 170 and while maintaining the specified minimum temperature Tmin. The controls thus allow the pressure losses to be minimized for each currently available temperature of the heat exchange medium, while maintaining the specified minimum temperature Tmin.

Another one of the rules stored in the control unit 240 can therefore be that the mass flow through the second bypass line 220 is increased if the temperature downstream of the second node 152 is above a predetermined threshold. This threshold value could be, for example, the predetermined minimum temperature Tmin or, for example, Tmin+T2, wherein T2 is, for example, 10% of Tmin or an absolute amount.

The bypass line 230 enables the additional passage of a mass flow through the heat exchanger 140, bypassing the internal heat exchanger 170. Thus, depending on the heat exchanger medium temperature, e.g., at a cold start, an additional length in the heat exchanger can be made usable and the heat exchanger 140 can be designed so as to be smaller overall because, in normal operation, higher heat exchanger medium temperatures can be assumed.

Another one of the rules stored in the control unit 240 can therefore be that the mass flow through the third bypass line 230 is increased if the temperature downstream of the second node 152 is below a predetermined threshold. This threshold could be, for example, the predetermined minimum temperature Tmin or, for example, Tmin+T3, wherein T3 is, for example, 10% of Tmin or an absolute amount.

Compensating for a Pressure in the Cryogenic Container that is Too Low, e.g., after Misfuelling

Under normal circumstances, the minimum pressure pmin the consumer requires for full load operation is, for example, 5 bar. Assuming that a static prior art removal system as shown in FIG. 1 offers a pressure loss Δp of 3 bar with a full load mass flow, a pressure pKB of 8 bar must prevail in the cryogenic container 100 so as to achieve the desired minimum pressure pmin of 5 bar downstream of the second node 152, following the removal system. With the system of FIG. 2, it is possible to allow the removal system to only have a pressure loss of 2 bar in full load operation thanks to the bypass lines 210, 220, 230, whereby the pressure pKB in the cryogenic container 100 has to be only 7 bar so as to achieve the desired minimum pressure pmin of 5 bar, following the removal system. The pressure reduction achieved by the bypass lines 210, 220, 230 results in the desired increase in the hold time.

Typically, the desired pressure pKB in the cryogenic container 100 will also be above 7 bar or, respectively, 8 bar so that the invention is used for reducing the pressure in the cryogenic container 100 in order to just reach the minimum pressure pmin at the end of the removal system. However, the invention also makes it possible that a pressure pKB in the cryogenic container 100 that is too low, e.g., after misfuelling, will not inevitably lead to a scenario in which the vehicle can no longer be started and would have to be towed away. This can happen especially during the refuelling of sLH2, since, in that case, the cryogenic fluid is brought into an overpressured state at the end of the refuelling process.

Initially, it may be assumed that the consumer now has a minimum pressure for partial load operation (e.g., for idling in order to heat the heat exchange medium or a “limp home” function for driving with reduced power) of, for example, 4 bar. If the pressure in the cryogenic container 100 is now only 5 bar because of the misfuelling, with a pressure loss of the removal system of 2 bar in partial load operation, it would not even be possible to operate the consumer with minimum power at 4 bar pressure. However, according to the invention, the pressure loss of the removal system can now be reduced, especially if a mass flow of cryogenic fluid is guided via the first bypass line 210. The pressure loss of the removal system can thus be reduced, for example, to 1 bar, whereby a minimum pressure of 4 bar is attainable at the consumer with a pressure pKB in the cryogenic container 100 of 5 bar. In this case, it can be accepted that the minimum temperature Tmin of the consumer is fallen short of to a certain degree over a predetermined period of time, e.g., 10 minutes.

By selectively connecting the bypass lines 210, 220, 230, the system also enables in this case that the pressure pKB in the cryogenic container 100 can be raised as quickly as possible, while the pressure downstream of the node 152 is kept essentially consistently at the minimum pressure pmin.

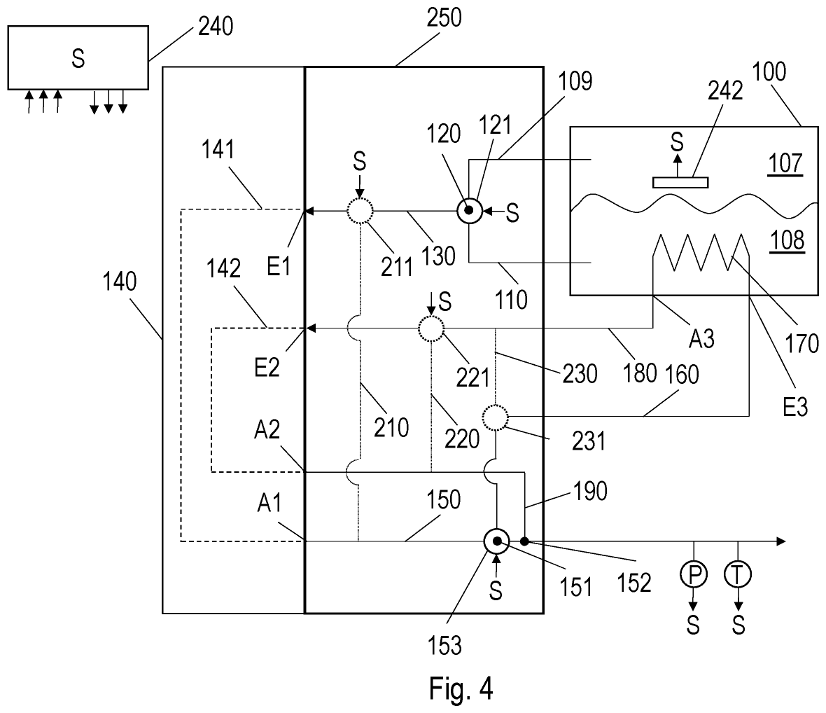

FIG. 4 shows that a large part of the removal system can be implemented in a single-piece valve block 250. The input lines 109, 110 and, respectively, 130, the output line 150, the branch line 160, the first return line 180, the second return line 190 and/or the bypass lines 210, 220, 230 can all be implemented at least partially, preferably completely, inside the single-piece valve block 250, e.g., from recesses such as holes in the single-piece valve block 250 which have been milled, drilled or produced in a casting process. The single-piece valve block 250 preferably has at least one, preferably two, inlet ports for the removal lines 109, 110 and, respectively, 130, an inlet port for the first return line 180, an outlet port for the output line 150 and an outlet port for the branch line 160, as well as four connection openings for the connection of the heat exchanger to the inlet ports E1, E2 and the outlet ports A1, A2, respectively. To implement the valves, the single-piece valve block 250 can have valve recesses starting at the corresponding lines within the single-piece valve block.

Two or more single-piece valve blocks can also be provided, for example, if the first single-piece valve block comprises the input lines 109, 110 and, respectively, 130 and the first return line 180, and the second single-piece valve block comprises the output line 150, the branch line 160 and the second return line 190. In this case, the two single-piece valve blocks could have appropriate connection openings for routing the bypass lines 210, 220, 230 between the single-piece valve blocks.

1-10. (canceled)

11. A system comprising:
a cryogenic container which is one of an LNG container or a hydrogen container,
an external heat exchanger and an internal heat exchanger,
wherein the external heat exchanger includes a medium inlet and a medium outlet for a heat exchange medium and the internal heat exchanger is arranged within the cryogenic container for utilizing the cryogenic fluid located in the cryogenic container as the heat exchange medium,
wherein the external heat exchanger comprises a first heat exchanger tube with a first inlet and a first outlet and a second heat exchanger tube with a second inlet and a second outlet, or wherein the external heat exchanger comprises only a first heat exchanger tube with a first inlet and a first outlet, and
the system furthermore comprises a further external heat exchanger with a second heat exchanger tube with a second inlet and a second outlet;
wherein the internal heat exchanger comprises a third inlet and a third outlet;
wherein a removal line of the cryogenic container is connected to the first inlet of the external heat exchanger,
with an output line being connected to a first outlet of the external heat exchanger,
with a branch line being connected to the output line at a first node and being connected to the third inlet of the internal heat exchanger, and
with a first return line being connected to the third outlet of the internal heat exchanger and being connected to the second inlet of the second heat exchanger tube; and
wherein a second return line is connected to the second outlet of the second heat exchanger tube and is connected to the output line at a second node, the second node being located downstream of the first node;
wherein the system comprises at least one of the following selectively connectable bypass lines:
a first bypass line for the first heat exchanger tube of the external heat exchanger, the first bypass line being connected to the removal line upstream of the first inlet and being connected to the output line downstream of the first outlet;
a second bypass line for the second heat exchanger tube, the second bypass line being connected to the first return line upstream of the second inlet and being connected to the second return line downstream of the second outlet;
a third bypass line for the internal heat exchanger, the third bypass line being connected to the branch line upstream of the third inlet and being connected to the first return line downstream of the third outlet.

12. The system according to claim 11, further comprising a control device and at least one sensor for determining pressure readings and/or temperature readings, the sensor being arranged in the cryogenic container, in the removal line, in the branch line, in the first return line, in the second return line or in the output line,
the control unit being designed for controlling a mass flow of cryogenic fluid through the first, second and/or third bypass line depending on the pressure readings and/or temperature readings received from the sensor.

13. The system according to claim 12, wherein the control unit is designed for receiving or determining a temperature downstream of the second node, a pressure downstream of the second node and a pressure in the cryogenic container and for controlling a mass flow via the branch line, the first, second and/or third bypass line, under the conditions that the temperature downstream of the second node is at or above a predetermined minimum temperature, the pressure downstream of the second node is at or above a predetermined minimum pressure and the pressure in the cryogenic container is minimized.

14. The system according to claim 12, wherein the control unit is designed for increasing the mass flow through the first bypass line or the second bypass line when the temperature downstream of the second node is above a predetermined threshold.

15. The system according claim 12, wherein the control unit is designed for increasing the mass flow through the third bypass line when the temperature downstream of the second node is below a predetermined threshold.

16. The system according to claim 12, wherein the system is designed for providing the heat exchange medium at a first temperature at the onset of an operation and, after a predetermined period of time upon the onset of the operation, for providing the heat exchange medium at a second temperature which is higher than the first temperature,
the external heat exchanger being designed for bringing the cryogenic fluid at least to the predetermined minimum temperature of a consumer at the onset of the operation when the cryogenic fluid is being passed through the first heat exchanger tube once, and
the control unit being designed so as not to guide any mass flow of cryogenic fluid via the first bypass line and/or the second bypass line at the onset of the operation and for guiding a mass flow of cryogenic fluid via the first bypass line and/or the second bypass line after the predetermined period of time, optionally under the condition that the temperature downstream of the second node is at a predetermined minimum temperature.

17. The system according to claim 12, wherein the system is designed for providing the heat exchange medium at a first temperature at the onset of an operation and, after a predetermined period of time upon the onset of the operation, for providing the heat exchange medium at a second temperature which is higher than the first temperature,
the external heat exchanger being designed for bringing the cryogenic fluid only to a temperature below the predetermined minimum temperature of a consumer at the onset of the operation when the cryogenic fluid is being passed through the first heat exchanger tube once, and
the control unit being designed for guiding a mass flow of cryogenic fluid via the third bypass line at the onset of the operation, optionally under the condition that the temperature downstream of the second node is at a predetermined minimum temperature, and so as not to guide any mass flow of cryogenic fluid via the third bypass line after the predetermined period of time.

18. The system according to claim 12, wherein the control unit is designed for increasing the mass flow of cryogenic fluid via the first bypass line when the pressure in the cryogenic container or downstream of the second node is below a predetermined threshold, the control unit preferably being designed for relaxing or suspending a condition regarding a required minimum temperature of the consumer.

19. The system according to claim 11, wherein the first bypass line has a valve at the connection point to the removal line, a valve at the connection point to the output line or a valve between said connection points;
wherein the second bypass line has a valve at the connection point to the first return line, a valve at the connection point to the second return line or a valve between said connection points; and/or
wherein the third bypass line has a valve at the connection point to the branch line, a valve at the connection point to the first return line or a valve between said connection points.

20. A vehicle comprising a system according to claim 11, wherein the output line is connected to a consumer, in particular an engine or a fuel cell, of the vehicle, the consumer being designed for operation in normal mode, when the consumer receives cryogenic fluid at a predetermined minimum temperature and a predetermined minimum pressure.
